(19) United States
(12) Patent Application Publication
(10) Pub. No.: US 2017/0289823 A1
(43) Pub. Date: Oct. 5, 2017

(54) Mobile communication terminal, method for optimizing wireless performance of the mobile communication terminal, electronic device and storage medium

(71) Applicants: Le Holdings (Beijing) Co., Ltd., Beijing (CN); Lemobile Information Technology (Beijing) Co., Ltd., Beijing (CN)

(72) Inventors: Huanqu HUANG, Beijing (CN); Bo CHENG, Beijing (CN); Junyi WANG, Beijing (CN); Lishan HUANG, Beijing (CN)

(21) Appl. No.: 15/241,738

(22) Filed: Aug. 19, 2016

Related U.S. Application Data
(63) Continuation of application No. PCT/CN2016/088826, filed on Jul. 6, 2016.

(30) Foreign Application Priority Data
Mar. 29, 2016 (CN) 2016101875758

(51) Int. Cl. H04W 24/02; H04W 72/04; H04B 17/318

(52) U.S. Cl. CPC H04W 24/02; H04B 17/318; H04W 72/0453; H04W 88/02

(57) ABSTRACT

A mobile communication terminal, a method for optimizing wireless performance, a device and storage medium thereof are provided. The method comprises: when sensing the terminal is located proximate to the head of a user, determining a band and channel that are currently used by the terminal according to the intensity of a received signal; adjusting a compensation network in an antenna circuit according to the band and channel, to weaken the transmission performance of an antenna corresponding to the band while improving the antenna reception performance.

### CROSS REFERENCE TO RELATED APPLICATIONS

This disclosure is a continuation of International Application No. PCT/CN2016/088826, filed on Jul. 6, 2016, which is based upon and claims priority to Chinese patent application No. 201610187575.8 entitled “Mobile Communication Terminal and Method and Device for Optimizing Wireless Performance of Mobile Communication Terminal”, filed with Chinese Patent Office on Mar. 29, 2016, which is incorporated herein by reference in its entirety.

### TECHNICAL FIELD

This disclosure relates to the field of mobile communication technologies, in particular to a mobile communication terminal, a method for optimizing wireless performance of the mobile communication terminal, a device and a storage medium.

### BACKGROUND

In 4G (fourth generation mobile communication) LTE and an era of wireless technologies beyond, as compared with 2G (second generation mobile communication) and 3G (third generation mobile communication), there are more requirements for the number of communication bands thereof, and frequencies of the bands are also becoming lower. To satisfy the technical development requirement, the industry improves performance of an antenna by using elements, such as a switch or a tunable element, in an antenna circuit, in addition to making efforts to perform antenna design.

In addition to the foregoing requirements for the number of the frequency bands, there is also a design requirement for a diversity antenna. As regards the diversity antenna design, generally, a main antenna is provided below (without limitation to) a body of a terminal, and a diversity antenna is provided above (without limitation to) the body, and the diversity antenna may also be called a secondary antenna. When the terminal having the antenna distribution character uses metal with an increasingly high proportion in appearance design, the main antenna below the body results in considerable deterioration and reduction due to grip. For this problem, a common solution is to detect antenna performance of the main antenna; when the performance of the main antenna deteriorates to below a certain threshold, a terminal system switches to the secondary antenna above (without limitation to) the body, and the secondary antenna completes a function of transmitting a wireless signal, so as to ensure quality of wireless communication to some extent.

Because wireless signal transmission generates electromagnetic radiation, when electromagnetic radiation reaches a certain amount, it causes hazards to a human body. Therefore, for a mobile communication terminal, international laws specify an upper threshold for power, of a terminal, of a specific absorption rate (SAR) of radiation by a human body. Only terminals that pass the SAR test can be marketed, so as to ensure personal safety of a user. When a user makes a conversation by using a terminal, performance of a main antenna deteriorates due to grip, and the terminal switches to a secondary antenna to operate. Generally, a secondary antenna is located in a place that is not easily blocked by limbs of a user, and the most common location is above the body. Therefore, when a user makes a conversion and makes the terminal proximate to a human head, in this case, electromagnetic radiation generated by the secondary antenna is large. To satisfy specifications of SAR, one solution is to reduce conducted power of an input antenna on a plate end. Because the conducted power of the input antenna is reduced, electromagnetic radiation thereof is naturally reduced so as to satisfy the specifications of SAR. However, the solution also brings a negative effect of reducing antenna performance, resulting in that antenna performance (namely, in transmit and receive bands) deteriorates when the antenna is proximate to the head of a human body, resulting in that wireless communication quality of the terminal is reduced. Furthermore, chips of some terminals do not support a function of reducing the conducted power when the terminal is proximate to the head of a human body after the antenna is switched, and therefore, in this case, terminals using the chips usually close the secondary antenna there above due to failure of passing the SAR test, and switch to the main antenna below the body. Therefore, when performance of the main antenna below the body is considerably reduced due to grip of a user, there is no other improvement or remedy solution for the wireless communication performance (the transmit part, in particular), resulting in that communication quality is reduced.

### SUMMARY

The technical problem to be resolved by this disclosure lies in, with respect to insufficiency of prior art, providing a mobile communication terminal and a method and an device for optimizing wireless performance of the mobile communication terminal, so as to reduce a specific absorption rate (SAR) of radiation by a human body to pass an SAR test as well as improve a receiving capability of a wireless signal.

To resolve the foregoing technical problem, according to an aspect of this disclosure, this disclosure provides a method for optimizing wireless performance of a mobile communication terminal, including:

Detecting a band and a channel that are currently used by the mobile communication terminal when sensing that a mobile communication terminal is proximate to the head of a user; and

Adjusting a compensation network in an antenna circuit according to the band and channel, so as to weaken performance of a transmit band of an antenna as well as improve performance of a receive band of the antenna.

To resolve the foregoing technical problem, according to another aspect of this disclosure, this disclosure provides an device, including:

at least one processor, and a storage which is communicated by at least one processor. Wherein, the storage stores executable instruction by the at least one processor. The instruction is executed by at least one processor and enables at least one processor to,
sense whether a mobile communication terminal is proximate to the head of a user,
detect a band and a channel that are currently used by the mobile communication terminal when sensing that a mobile communication terminal is proximate to the head of a user, and
adjust a compensation network in an antenna circuit according to the current band and channel, so as to weaken performance of a transmit band of an antenna as well as improve performance of a receive band of the antenna.

To resolve the foregoing technical problem, according to an aspect of this disclosure, this disclosure provides a mobile communication terminal. The mobile communication terminal includes above mentioned device.

To resolve the foregoing technical problem, in another aspect of the disclosure, there is provided with non-transitory computer storage medium which storing computer executable instruction. The computer executable instruction is used for:
detecting a band and a channel that are currently used by the mobile communication terminal when sensing that a mobile communication terminal is proximate to the head of a user, and
adjusting a compensation network in an antenna circuit according to the current band and channel, so as to weaken performance of a transmit band of an antenna as well as improve performance of a receive band of the antenna.

When the terminal switches from the main antenna to the secondary antenna, by using the foregoing method and device, performance of the antenna transmit band is appropriately reduced deliberately, and therefore effects of radiation-out power on a human body are reduced, and the SAR test can be passed without having to reduce conducted power output by the plate end to the antenna. Moreover, at the same time, this disclosure further improves performance of the antenna receive band, so as to improve communication quality. Moreover, this disclosure may also be used along with the method of reducing the conducted power output by the plate end to the antenna, so as to further ensure that the SAR test can be passed, and overcome the shortcoming that the method reduces the antenna receive performance.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed

FIG. 1 schematically illustrates a flowchart of the method for optimizing wireless performance of a mobile communication terminal according to the embodiment of this disclosure;

FIG. 2 schematically illustrates an antenna performance contrast diagram obtained after a wireless performance test is performed on a terminal according to the embodiment of this disclosure;

FIG. 3 schematically illustrates a partial flowchart of a specific embodiment in the method for optimizing wireless performance of a mobile communication terminal according to the embodiment of this disclosure;

FIG. 4 schematically illustrates a partial flowchart of another specific embodiment in the method for optimizing wireless performance of a mobile communication terminal according to the embodiment of this disclosure;

FIG. 5 schematically illustrates a principle block diagram of the device for optimizing wireless performance of a mobile communication terminal according to the embodiment of this disclosure;

FIG. 6 schematically illustrates a principle block diagram about a specific embodiment of a control module in the device for optimizing wireless performance of a mobile communication terminal according to the embodiment of this disclosure;

FIG. 7 schematically illustrates a principle block diagram about another specific embodiment of a control module in the device for optimizing wireless performance of a mobile communication terminal according to the embodiment of this disclosure;

FIG. 8 schematically illustrates a circuit principle schematic diagram about a specific embodiment of a compensation network in the device for optimizing wireless performance of a mobile communication terminal according to the embodiment of this disclosure;

FIG. 9 schematically illustrates a circuit principle schematic diagram about another specific embodiment of a compensation network in the device for optimizing wireless performance of a mobile communication terminal according to the embodiment of this disclosure; and

FIG. 10 schematically illustrates hardware structure of a device for executing a method for optimizing wireless performance of a mobile communication terminal according to an embodiment of this disclosure;

### DETAILED DESCRIPTION

The exemplary embodiments of this disclosure are described below in details with reference to the accompanying drawings. Although the exemplary embodiments of this disclosure are shown in the accompanying drawings, it should be understood that this disclosure can be embodied in various forms and is not limited to the embodiments set forth herein. Rather, these embodiments are provided to make this disclosure to be understood more clearly and to fully present this disclosure in its entirety to the persons having ordinary skill in the art.

Referring to FIGS. 1 and 5, FIG. 1 schematically illustrates a flowchart of the method for optimizing the wireless performance of a mobile communication terminal according to the embodiment of this disclosure. FIG. 5 schematically illustrates a principle block diagram of a device for optimizing the wireless performance of a mobile communication terminal according to the embodiment of this disclosure. A device for optimizing the wireless performance of a mobile communication terminal of this disclosure includes a head detection module 1, a band and channel detection module 2 and a control module 3. In connection with FIGS. 1 and 5, the method and device according to the embodiment of this disclosure are described in details.

A method for optimizing the wireless performance of a mobile communication terminal according to the embodiment of this disclosure includes the following steps:

Step S1, acquiring a band and channel that are currently used by a terminal according to the intensity of a received signal by the band and channel detection module 2 in a device of this disclosure.

Step S2, judging whether a head sensing signal is received. The head detection module 1 in the device of this disclosure can sense whether a terminal is proximate to the head of a user. In a particular embodiment, various types of distance sensors can be used, such as close-to-light sensors, infrared sensors, capacitance sensors, etc. When sensing that the terminal is proximate to the head of a user, the sensor emits a sensing signal. In the case of not receiving sensing signal, the process is ended without any treatment, and in the case of receiving the head sensing signal, it proceeds to Step S3.

Step S3, receiving the band and channel acquired in Step S1 by the control module 3, adjusting a compensation network 4 in an antenna circuit according to the band and channel so as to properly weaken the antenna transmission performance corresponding to the band while also improving the antenna reception performance.

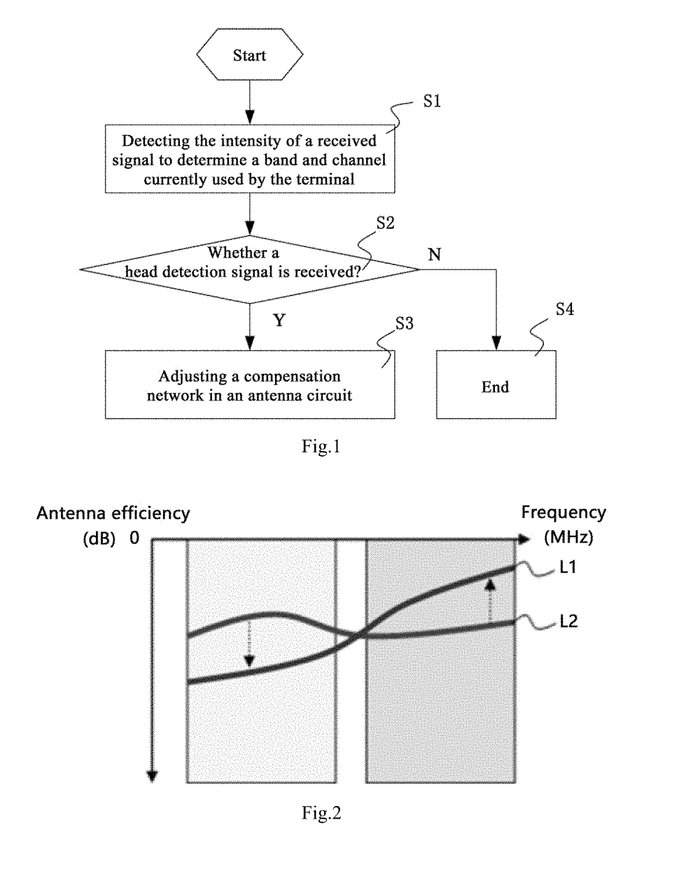

In this disclosure, via the compensation network, the antenna transmission performance corresponding to the communication band or channel is intentionally deteriorated to an appropriate extent, that is, a deterioration degree available to SAR test specifications, so as to reduce the impact of radiation-induced power on human body and also improve the band or channel reception performance of the antenna. As shown in FIG. 2, a comparative view of terminal antenna performance is schematically illustrated. Wherein, the vertical axis represents the antenna efficiency, in dB as unit, and the horizontal axis represents the frequency, in MHz as unit. The curve L1 is a curve resulting from the test of a terminal to which the method and device of this disclosure is applied, and the curve L2 is a curve resulting from the test of a common terminal. It can be seen from the figures that the performance of power of terminal according to the embodiment is lowered at the transmit band TX but raised at the receive band RX. As such, the test complying with SAR specifications can be performed, and as compared to the prior art, the reception quality of wireless communication is improved and also the limitation from chip functions is, avoiding the problem that SAR test does not pass when the terminal chip fails to support the function that in-field trigger reduces conducted power from the plate end input to the antenna (particularly after switching to a secondary antenna).

In the above step S3, the control module 3 that controls the compensation network in the antenna circuit according to the received band and channel may have various modes, two of which are described in the embodiments. However, it should be understood by those skilled in the art that other embodiments that may also be utilized, and the solution of deteriorating the performance of the antenna at the transmit band by controlling the antenna circuit and simultaneously improving at the receive band are contained within the scope of this disclosure.

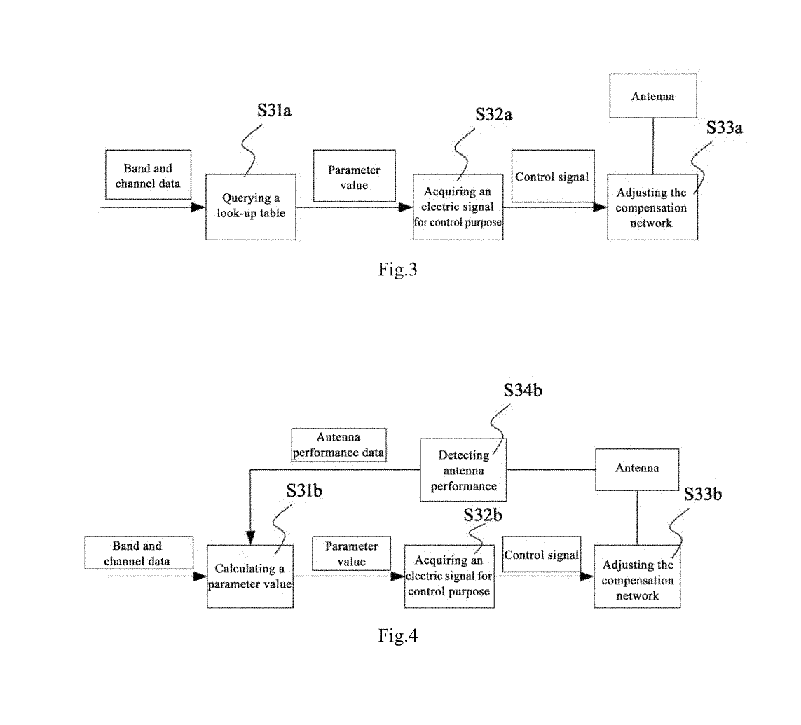

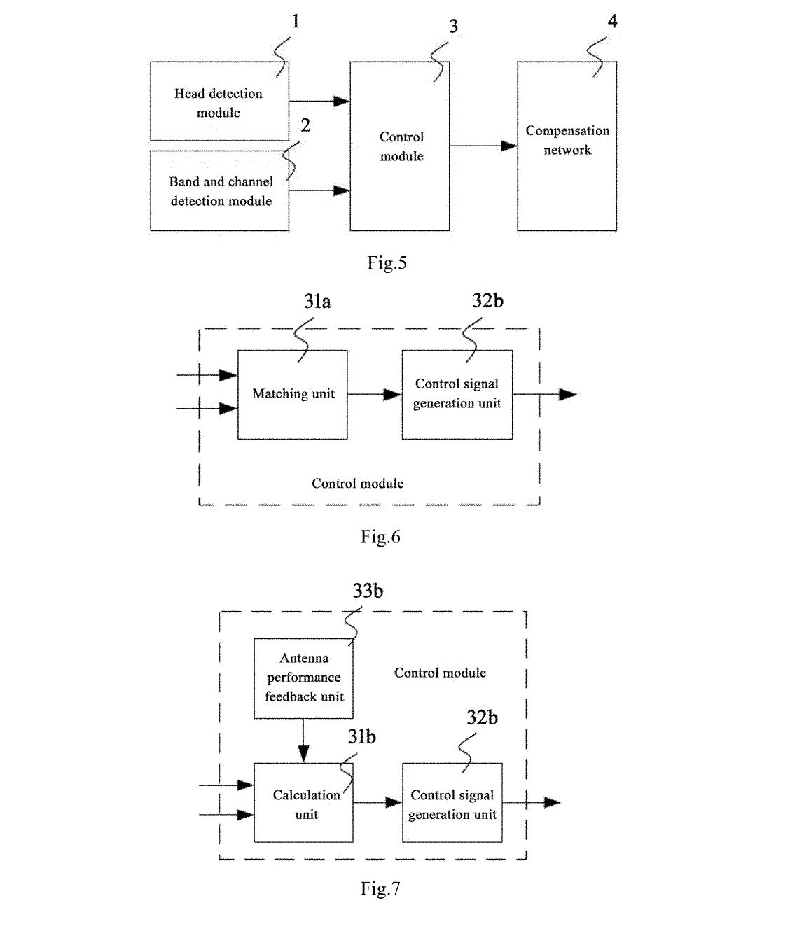

As shown in FIG. 3, a partial flow chart of a specific embodiment of a method for optimizing the wireless performance of a mobile communication terminal according to the embodiment of this disclosure is schematically illustrated. As shown in FIG. 6, a principle block diagram about a specific embodiment of a control module 3 in a device for optimizing the wireless performance of a mobile communication terminal of this disclosure is schematically illustrated. In connection with FIGS. 3 and 6, a compensation network in an antenna circuit controlled according to the band and channel is illustrated in details.

After acquiring the data of band and channel at which the terminal locates, in step S31a, a matching unit 31a queries in a look-up table prestored in a built-in memory and then finds the matched compensation network parameter value. After acquiring the parameter value, they are transmitted to a control signal generation unit 32a.

Step S32a, converting the particular parameter value into corresponding electrical signals which act as control signals by the control signal generation unit 32a, and then transmitting the signals to the corresponding terminals of a compensation network 4.

Step S33a, regulating the compensation network 4 to vary the performance of an antenna connected to the compensation network 4, thereby deteriorating the transmission performance and optimizing the reception performance. The deterioration degree is related to the parameters of the compensation network 4.

In this embodiment, the parameters in the look-up table are determined on the basis of extensive experiments and tests. Based on different deterioration degrees of the transmission performance and different optimizing degrees of the reception performance, optimum parameter sets for different bands are obtained by tests. The method provided by this example has simple algorithm, less resource occupied and fast response.

As shown in FIG. 4, FIG. 4 illustrates a partial flowchart of another specific embodiment of the method for optimizing wireless performance of a mobile communication terminal of this disclosure; as shown in FIG. 7, FIG. 7 illustrates a principle block diagram about another specific embodiment of a control module 3 in the device for optimizing wireless performance of a mobile communication terminal of this disclosure; In combination with FIGS. 4 and 7, a compensation network in an antenna circuit controlled according to the band and channel is described in details.

The control module 3 includes a calculation unit 31b, a control signal generation unit 32b, and an antenna performance feedback unit 33b.

Step S31b, the calculation unit 31b receives band and channel data obtained by the band and channel detection module 2 and antenna performance data detected by the antenna performance feedback unit 33b, and calculates according to a known circuit structure of the compensation network to obtain a parameter value of a circuit that can reduce antenna transmit performance as well as improve antenna receive performance.

Step S32b, the control signal generation unit 32b receives the parameter value, and converts the parameter value into a corresponding electric signal, namely, a control signal that is used to control the compensation network.

Step S33b, adjusting the compensation network 4 so as to make performance of an antenna connected to the compensation network 4 change, thereby deteriorating transmit performance and optimizing receive performance.

Step S34b, the antenna performance feedback unit 33b detects antenna performance to obtain antenna performance data at the moment, and sends the antenna performance data to the calculation unit 31b.

In the foregoing method and device, control data that adjusts the compensation network 4 is generated in real-time, and according to the returned antenna performance data, the obtained control data is corrected in time, so as to form an adaptive closed-loop control manner. The control data is a specific value of a tunable element or a logic state of a switch.

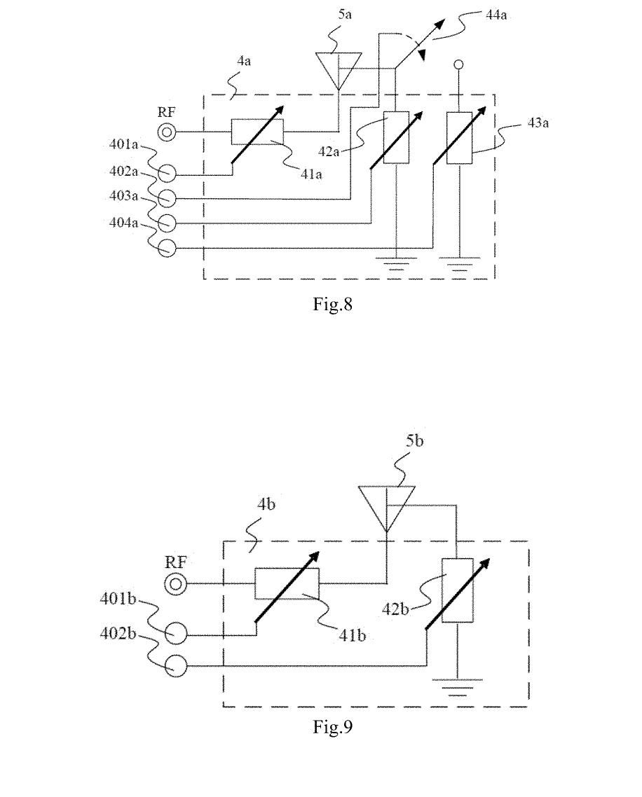

The compensation network 4 in this disclosure is a circuit formed of a tunable element or a tunable element and a switch. The tunable element is a tunable capacitor and/or tunable inductor. Specific embodiments thereof are shown in FIGS. 8 and 9, wherein FIG. 8 shows a circuit having a switch, and FIG. 9 shows a circuit without a switch.

As shown in FIG. 8, a compensation network 4a includes a feed compensation branch 41a; one end thereof is connected to a feed end of an antenna 5a, and the other end is connected to a radio frequency circuit via a radio frequency terminal RF. The compensation network 4a further includes two grounded compensation branches 42a and 43b, which are connected to a grounded end of the antenna 5a via a switch 44a. The three compensation branches are all formed by tunable elements, and tunable control ends thereof and a tunable control end of the switch are connected to the control module 3 via terminals 401a, 402a, 403a, and 404a, receive a control signal sent from the control module 3, and according to the control signal, change states of the tunable elements and the switch in the branches so as to change antenna performance, thereby reducing antenna transmit performance and improving antenna receive performance.

FIG. 9 differs from FIG. 8 in that FIG. 9 does not include a switch, and only has a group of grounded compensation branches 42b. In FIG. 8 and FIG. 9, although the compensation branch shown in the figures is one element, it does not indicate that there is only one element in actual implementation; FIG. 8 and FIG. 9 are merely principle schematic diagrams, and one or more elements may be included. For example, various kinds of T-shaped networks, π-shaped networks, or circuit networks of other types can be formed for three kinds of elements: inductors, capacitors, and resistors.

This disclosure further provides a mobile communication terminal; the mobile communication terminal of this disclosure includes a processor 100 and other modules 200. The processor 100 is configured to sense whether the mobile communication terminal is located proximate to the head of a user. The processor can use various types of distance sensors to sense whether the mobile communication terminal is located proximate to the user head according to specific actual design requirements. The processor sends a sensing signal to the processing unit; after receiving the sensing signal, the processing unit detects a band and a channel that are currently used by the mobile communication terminal, and adjusts the compensation network in an antenna circuit according to the band and channel, so as to weaken transmit band performance of the antenna as well as improve receive band performance of the antenna. The processing unit specifically may include a band and channel detection module and control module in the foregoing device for optimizing wireless performance of the mobile communication terminal; structures, principles and functions of the band and channel detection module and control module have been previously described, and are not repeatedly described herein. The other modules 300 include various modules, and circuits such as an antenna circuit, or a radio frequency circuit that are required by the mobile communication terminal, so as to complete the function of mobile communication.

Further, an embodiment of the present disclosure further provides a non-transitory computer-readable storage medium storing executable instructions, which can be executed by an electronic device to perform any methods for optimizing wireless performance of the mobile communication terminal mentioned by embodiments of the present disclosure.

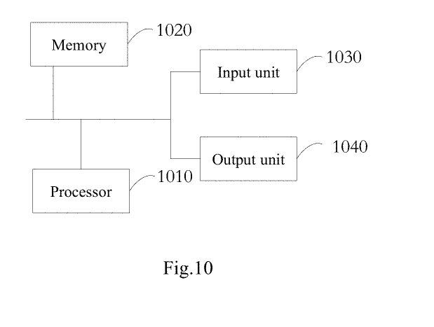

FIG. 10 schematically illustrates hardware structure of a device for executing a method for optimizing wireless performance of a mobile communication terminal according to an embodiment of this disclosure. As shown in FIG. 10, the device includes: one or more processor 1010 and memory 1020. A processor 1010 is showed in FIG. 10 for an example.

Device for executing a method for optimizing wireless performance of a mobile communication terminal can also include: input unit 1030 and output unit 1040.

Processor 1010, memory 1020, input unit 1030 and output unit 1040 can be connected by BUS or other methods, and BUS connecting is showed in FIG. 10 for an example.

Memory 1020 can be used for storing non-transitory software program, non-transitory computer executable program and modules as a non-transitory computer-readable storage medium, such as corresponding program instructions/modules for the methods for optimizing wireless performance of a mobile communication terminal mentioned by embodiments of the disclosure. Processor 1010 performs kinds of functions and data processing as a server by executing non-transitory software program, instructions and modules which are stored in memory 1020, thereby realizes the methods mentioned by embodiments of the present disclosure.

Memory 1020 can include program storage area and data storage area, thereby the operating system and applications required by at least one function can be stored in program storage area and data created by using the device for performing the methods mentioned by the embodiment can be stored in data storage area. Furthermore, memory 1020 can include high speed Random-access memory (RAM) or non-volatile memory such as magnetic disk storage device, flash memory device or other non-volatile solid state storage devices. In some embodiments, memory 1020 can include long-distance setup memories relative to processor 1010, which through networks, communicates with the device for performing the methods mentioned by the embodiment. The examples of said networks are including but not limited to Internet, Intranet, LAN, mobile Internet and their combinations.

Input unit 1030 can be used to receive inputted number, character information and key signals causing user configures and function controls of the device for performing the methods mentioned by the embodiment. Output unit 1040 can include a display screen or a display device.

The said module or modules are stored in memory 1020 and perform the methods for optimizing wireless performance of a mobile communication terminal when executed by one or more processors 1010.

The said device can reach the corresponding advantages by including the function modules or performing the methods provided by embodiments of the present disclosure. Those methods can be referenced for technical details which may not be completely described in this embodiment.

The devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-13. (canceled)

14. A method for optimizing wireless performance of a mobile communication terminal, including:
detecting a band and a channel that are currently used by the mobile communication terminal when sensing that the mobile communication terminal is located proximate to the head of a user; and
adjusting a compensation network in an antenna circuit according to the band and channel, so as to weaken performance of a transmit band of an antenna as well as improve performance of a receive band of the antenna.

15. The method for optimizing wireless performance of a mobile communication terminal according to claim 14, wherein the adjusting a compensation network in an antenna circuit according to the band and channel includes the following steps:
querying according to the determined band and channel, in a preset look-up table, a compensation network parameter value matched with the determined band and channel; and
adjusting the compensation network in the antenna circuit according to the parameter value.

16. The method for optimizing wireless performance of a mobile communication terminal according to claim 14, wherein the adjusting a compensation network in an antenna circuit according to the band and channel includes:
calculating a parameter value of a compensation network according to the determined band and channel;
adjusting the compensation network in the antenna circuit according to the parameter value;
receiving performance data fed back from the antenna, and optimizing the parameter value of the compensation network according to the performance data, and
adjusting the compensation network in the antenna circuit according to the parameter value.

17. The method for optimizing wireless performance of a mobile communication terminal of claim 14, wherein the adjusting a compensation network in an antenna circuit according to the band and channel includes:
adjusting the value of an tunable element in the antenna circuit according to the band and channel;
or,
adjusting the value of an tunable element and a logic state of a switch in the antenna circuit according to the band and channel.

18. The method for optimizing wireless performance of a mobile communication terminal of claim 17, wherein the tunable element is at least one of a tunable capacitor and a tunable inductor.

19. The method for optimizing wireless performance of a mobile communication terminal of claim 14, wherein a sensor in the mobile communication terminal senses whether a mobile communication terminal is located proximate to the head of a user.

20. A device, comprising:
at least one processor, and
a storage, which is communicated by at least one processor.
Wherein, the storage stores executable instruction by the at least one processor. The instruction is executed by at least one processor and enables at least one processor to sense whether a mobile communication terminal is proximate to the head of a user, detect a band and a channel that are currently used by the mobile communication terminal when sensing that a mobile communication terminal is proximate to the head of a user, and
adjust a compensation network in an antenna circuit according to the current band and channel, so as to weaken performance of a transmit band of an antenna as well as improve performance of a receive band of the antenna.

21. The device according to claim 20, wherein a distance sensor is used for sensing whether a mobile communication terminal is proximate to the head of a user.

22. The device according to claim 20, wherein the compensation network comprises a tunable element, or the compensation network comprises a tunable element and a switch.

23. The device according to claim 22, wherein the tunable element is at least one of a tunable capacitor and a tunable inductor.

24. The device according to claim 20, wherein the instruction enables the at least one processor to
query a compensation network parameter value matched with the determined band and channel according to the received band and channel data in a preset look-up table; and
generate a control signal of the compensation network according to the parameter value.

25. The device according to claim 20, wherein the instruction enables the at least one processor to
calculate a current transmission power and received power of the antenna to obtain current performance data of the antenna;
calculate a circuit parameter value for reducing the antenna transmission performance while improving the reception performance, according to the band and channel data, the antenna performance data, and a circuit structure of the compensation network; and
generate a control signal of the compensation network according to the parameter value.

26. A mobile communication terminal, including the device according to claim 20.

27. A non-transitory computer storage medium, which stores computer executable instruction. The computer executable instruction is set for:
detecting a band and a channel that are currently used by the mobile communication terminal when sensing that a mobile communication terminal is proximate to the head of a user, and
adjusting a compensation network in an antenna circuit according to the current band and channel, so as to weaken performance of a transmit band of an antenna as well as improve performance of a receive band of the antenna.
